(19) United States
(12) Patent Application Publication
(10) Pub. No.: US 2022/0107529 A1
(43) Pub. Date: Apr. 7, 2022

(54) BACKLIGHT MODULE AND DISPLAY DEVICE HAVING THE SAME

(71) Applicant: TCL CHINA STAR OPTOELECTORINCS THEHNOLOGY CO., LTD., Shenzhen, Guangdong (CN)

(72) Inventor: Jinyang ZHAO, Shenzhen (CN)

(21) Appl. No.: 16/764,244

(22) PCT Filed: Apr. 8, 2020
(86) PCT No.: PCT/CN2020/083677

§ 371 Date: May 14, 2020

(30) Foreign Application Priority Data
Mar. 13, 2020 (CN) 202010173294.3

(51) Int. Cl. G02F 1/13357; G02F 1/1335

(52) U.S. Cl. CPC G02F 1/133603; G02F 1/133611; G02F 1/133606; G02F 1/133614; G02F 1/133608

(57) ABSTRACT

A backlight module is provided. A brightness enhancing layer is disposed on a surface of light-emitting layer. The brightness enhancing layer comprises a plurality of optical microcavities, and each of the microcavities is configured to resonate a part of light emitted by and entering the light-emitting layer to obtain resonant light and emit the resonant light. The backlight module can greatly improve brightness of the light-emitting layer. Furthermore, a display device having the backlight module is also provided.

### BACKGROUND OF INVENTION

### Field of Invention

The present invention relates to the field of display technology, and more particularly, to a backlight module and a display device having the same.

### Description of Prior Art

Mini light emitting diodes (Mini-LEDs) are light-emitting components obtained by miniaturizing size of traditional light-emitting diodes (LEDs). Because the size of the mini light emitting diodes is smaller than the traditional LEDs, it is used in displays to increase display screen resolution.

Generally, Mini-LEDs are used in the backlight module, and the backlight module is combined with a liquid crystal display (LCD) panel to form an LCD display. In order to improve the contrast of the display screen, it is necessary to increase the brightness of the Mini-LEDs. In the prior art, the reflection method may usually increase the brightness of the Mini-LED, but this method has a little improvement on the brightness of the Mini-LED.

### SUMMARY OF INVENTION

A backlight module and a display device having the same are provided to solve the technical problem of the backlight module and the display device with low brightness.

A backlight module comprises:

a light-emitting layer; and

a brightness enhancing layer disposed on a surface of the light-emitting layer, wherein the brightness enhancing layer comprises a plurality of optical microcavities, and each of the microcavities is configured to resonate a part of light emitted by and entering the light-emitting layer to obtain resonant light and emit the resonant light.

In one embodiment, each of the optical microcavities comprises a solid spherical structure.

In one embodiment, a refractive index of each of optical microcavities ranges from 1.8 to 2.5.

In one embodiment, material of each of optical microcavities comprises any one or a combination of barium titanate, barium oxide, titanium dioxide, silicon dioxide, and lithium oxide.

In one embodiment, a diameter of each of the optical microcavities ranges from 20 to 200 μm.

In one embodiment, the plurality of the optical microcavities are uniformly arranged in a single-layered array.

In one embodiment, each of the optical microcavities is tangent to at least two remaining optical microcavities.

In one embodiment, each of the optical microcavities is a solid cylindrical structure or a solid ring structure.

In one embodiment, the light-emitting layer comprises a plurality of small light-emitting diodes emitting blue light, and between the light-emitting layer and the brightness enhancing layer, the backlight module further comprises:

a support structure disposed on the surface of the light-emitting layer;

a diffusion plate disposed on the surface of the support structure; and

a quantum dot film disposed on the surface of the diffusion plate. The brightness enhancing layer is disposed on the surface of the quantum dot film.

In one embodiment, the backlight module further comprises:

a diffusion sheet disposed on the surface of the brightness enhancing layer; and

a dual brightness enhancement film disposed on a surface of the diffusion sheet.

A display device comprises:

display panel; and

a backlight module. The backlight module comprises a light-emitting layer and a brightness enhancing layer, and the brightness enhancing layer is disposed on a surface of the light-emitting layer. The brightness enhancing layer comprises a plurality of optical microcavities, and each of the microcavities is configured to resonate a part of light emitted by and entering the light-emitting layer to obtain resonant light and emit the resonant light.

In one embodiment, each of the optical microcavities comprises a solid spherical structure.

In one embodiment, a refractive index of each of the optical microcavities ranges from 1.8 to 2.5.

In one embodiment, material of each of optical microcavities comprises any one or a combination of barium titanate, barium oxide, titanium dioxide, silicon dioxide, and lithium oxide.

In one embodiment, a diameter of each of the optical microcavities ranges from 20 to 200 μm.

In one embodiment, the plurality of the optical microcavities are uniformly arranged in a single-layered array.

In one embodiment, each of the optical microcavities is tangent to at least two remaining optical microcavities.

In one embodiment, each of the optical microcavities is a solid cylindrical structure or a solid ring structure.

In one embodiment, the light-emitting layer comprises a plurality of small light-emitting diodes emitting blue light, and between the light-emitting layer and the brightness enhancing layer, the backlight module further comprises:

a support structure disposed on the surface of the light-emitting layer;

a diffusion plate disposed on the surface of the support structure;

a quantum dot film disposed on the surface of the diffusion plate; and

the brightness enhancing layer disposed on the surface of the quantum dot film.

In one embodiment, the display device further comprises:

a diffusion sheet disposed on the surface of the brightness enhancing layer; and a dual brightness enhancement film disposed on a surface of the diffusion sheet.

The present invention has beneficial effects described as follows. A brightness enhancing layer is disposed on the surface of the light-emitting layer in the backlight module. By designing the brightness enhancement layer as an optical microcavity, the intensity of a part of the light emitted into the optical microcavity by the light emitting layer is greatly enhanced and emitted based on the WGM resonance effect and the antenna effect of the optical microcavity. Therefore, the brightness of the light-emitting layer is improved.

### BRIEF DESCRIPTION OF DRAWINGS

FIG. 1 is a schematic view of a backlight module according to first embodiment of the present invention.

FIG. 2 is a top view of a backlight module according to sixth embodiment of the present invention.

FIG. 3 is a top view of a backlight module according to seventh embodiment of the present invention.

FIG. 4 is a schematic view of an optical microcavity according to eighth embodiment of the present invention.

FIG. 5 is a schematic view of a backlight module according to a ninth embodiment of the present invention.

FIG. 6 is a schematic view of a backlight module according to a tenth embodiment of the present invention.

FIG. 7 is a schematic view of a display device according to an eleventh embodiment of the present invention.

### DETAILED DESCRIPTION OF PREFERRED EMBODIMENTS

In order to make the purpose, technical solutions and effects of the present invention clear, the present invention will be described in further detail below with reference to the accompanying drawings and examples. It should be understood that the specific embodiments described herein are only used to explain the present invention, and are not used to limit the present invention.

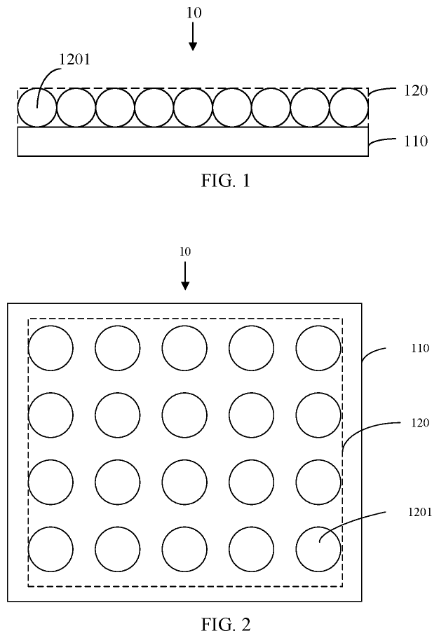

FIG. 1 is a schematic view of a backlight module according to first embodiment of the present invention. Referring to FIG. 1, the backlight module 10 includes a light-emitting layer 110 and a brightness enhancing layer 120 disposed on the surface of the light-emitting layer 110.

The light-emitting layer 110 is a functional layer with a light-emitting function. For example, the light-emitting layer 110 may comprise a number of Mini-LEDs, a quantum dot (QD), light-emitting film, a dye light-emitting film, an organic light-emitting diode (OLED), or quantum dot light emitting diodes (QLED), which are not specifically limited in the embodiments of the present invention.

The brightness enhancing layer 120 is a functional layer with a brightness enhancement function. In the embodiment of the present invention, the brightness enhancing layer 120 includes a plurality of optical microcavities 1201. Among them, the optical microcavity 1201 is a shape-dependent optical resonant cavity, which mainly includes spherical, cylindrical, and annular shapes. The optical microcavity 1201 has a spherical shape as shown in FIG. 1.

As for each of the optical microcavities 1201, the light emitted from the light-emitting layer 110 into the optical microcavity 1201 is called incident light. Based on the resonance effect and antenna effect of the Whispering Gallery Mode (WGM) of the optical microcavity 1201, it can greatly increase the intensity of incident light at a specific wavelength and the light is emitted from the optical microcavity 1201 in a specific direction. For convenience of description, this part of the light is called resonant light.

As the intensity of the light is stronger, the brightness is greater, so the brightness of the resonant light is greatly improved compared to the incident light. The studies show that the brightness of the resonant light is increased by 2 to 3 orders of magnitude compared to the brightness of the incident light.

In the backlight module 10 provided by the embodiment of the present invention, a brightness enhancing layer 120 is disposed on the surface of the light-emitting layer 110. By designing the brightness enhancing layer 120 as an optical microcavity 1201, the intensity of part of the light emitted by the light-emitting layer 110 into the optical microcavity 1201 is greatly enhanced and emitted based on the resonance effect and antenna effect of the Whispering Gallery Mode (WGM) of the optical microcavity 1201, thereby greatly improving the brightness of the light-emitting layer 110.

Based on any of the above embodiments, each of the optical microcavities 1201 is a solid cylindrical structure in second embodiment.

Based on any of the above embodiments, a refractive index of each of optical microcavities 1201 ranges from 1.8 to 2.5.

Specifically, in order to make the brightness of the resonant light emitted by the optical microcavity 1201 higher, the quality factor of the optical microcavity 1201 needs to be improved. The quality factor of the optical microcavity 1201 is related to its own refractive index and size, so the quality factor is improved based on the high refractive index. Therefore, in this embodiment, the refractive index of each optical microcavity 1201 is set to any value between 1.8 and 2.5.

Based on any of the above embodiments, transparent material of each of the optical microcavities 1201 includes any one or a combination of barium titanate (BaTiO₃), barium oxide (BaO), titanium dioxide (TiO₂), silicon dioxide, and lithium oxide (Li₂O) in fourth embodiment.

Specifically, the optical microcavity 1201 has a relatively high refractive index between 1.8 and 2.5, so a transparent material with a high refractive index is selected to manufacture the optical microcavity 1201. The material of optical microcavity 1201 in the embodiment of the present embodiment may be any one or a combination of BaTiO₃, BaO, TiO₂, SiO₂, and Li₂O. Of course, it may also be other transparent materials with high refractive index within 1.8-2.5, and is not specifically limited herein.

Based on any of the above embodiments, a diameter of each of the optical microcavities 1201 ranges from 20 to 200 μm in fifth embodiment.

Specifically, as the size of the optical microcavity 1201 is greater, the bending loss is lesser. Therefore, the quality factor increases, the brightness of the resonant light emitted by the optical microcavity 1201 is also increased. Accordingly, a diameter of the optical microcavity 1201 ranges from 20-200 μm. However, considering the complexity of the manufacturing process of the optical microcavity 1201 and other factors, the diameter of each optical microcavity 1201 preferably ranges from 40-60 μm in the embodiment of the present invention.

Based on any of the above embodiments, FIG. 2 is a top view of a backlight module according to sixth embodiment of the present invention. Referring to FIG. 2, the backlight module 10 includes a light-emitting layer 110 and a brightness enhancing layer 120 disposed on the surface of the light-emitting layer 110. The brightness enhancing layer 120 includes a plurality of optical microcavities 1201, which are uniformly arranged in a single-layered array.

Specifically, the brightness enhancing layer 120 includes twenty optical microcavities 1201. The twenty optical microcavities 1201 cover a large area of the surface of the brightness enhancing layer 120, and are uniformly arranged in a single-layered array of 4 columns×5 rows. The five optical microcavities 1201 in each column are spaced apart from each other, and four optical microcavities 1201 in each row are spaced apart from each other.

It should be noted that if the arrangement of the optical microcavities 1201 on the surface of the light-emitting layer 110 is more uniform, the light emitted by the light-emitting layer 110 can be improved in brightness uniformity. Referring to FIG. 2, the arrangement of the microcavities 1201 can make the light emitted by the light-emitting layer 110 more uniformly improved in brightness.

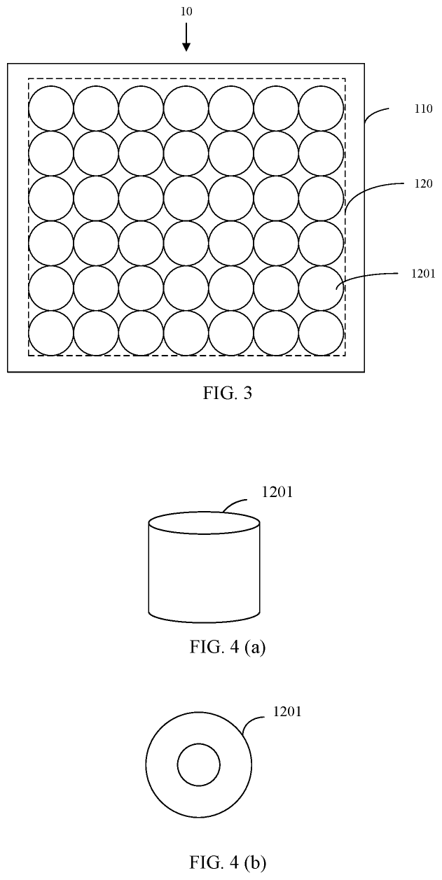

Based on any of the above embodiments, FIG. 3 is a top view of a backlight module according to seventh embodiment of the present invention. Referring to FIG. 3, the backlight module 10 includes a light-emitting layer 110 and a brightness enhancing layer 120 disposed on the surface of the light-emitting layer 110. The brightness enhancing layer 120 includes a plurality of optical microcavities 1201, which are uniformly arranged in a single-layered array, and each of the optical microcavities 1201 is tangent to at least two remaining optical microcavities 1201.

Specifically, the brightness enhancing layer 120 includes forty-two optical microcavities 1201. The forty-two optical microcavities 1201 cover a large area of the surface of the brightness enhancing layer 120, and are uniformly arranged in a single-layered array of 6 columns×7 rows. For each column, two adjacent optical microcavities 1201 are tangent to each other in the column of seven optical microcavities 1201. For each row, two adjacent optical microcavities 1201 are tangent to each other in the row of six optical microcavities 1201.

It should be noted that, the arrangement of the plurality of optical microcavities 1201 in the brightness enhancing layer 120 shown in FIG. 3 is more compact than that in FIG. 2, so the number of optical microcavities 1201 covering the surface of the light emitting-layer 110 is greater. Compared with FIG. 2, the light emitted by the light-emitting layer 110 in FIG. 3 can be more uniformly brightened.

Based on any of the above embodiments, each of the optical microcavities 1201 is a solid cylindrical structure or a solid ring structure in eighth embodiment. FIG. 4 is a schematic view of an optical microcavity according to eighth embodiment of the present invention. The optical microcavity 1201 illustrated in part (a) of FIG. 4 is a solid cylindrical structure, and the optical microcavity 1201 illustrated in part (b) of FIG. 4 is a solid ring structure.

Based on any of the above embodiments, process of forming the brightness enhancing layer 120 on the surface of the light-emitting layer 110 is described as follows:

Step 1: providing a plurality of optical microcavities 1201, and the plurality of optical microcavities 1201 are sprayed onto the surface of the light-emitting layer 110, and the plurality of optical microcavities 1201 are attached to the surface of the light-emitting layer 110 by electrostatic force and Van der Waals force.

Step 2: An adhesive tape with low adhesion is pressed on the surface of the light-emitting layer 110. After a while, the adhesive tape is peeled off, so as to remove the optical microcavity 1201 that is not attached to the surface of the light-emitting layer 110.

Step 3: repeat Step 1 and Step 2 until the brightness enhancing layer 120 as shown in FIG. 2 or FIG. 3 is formed.

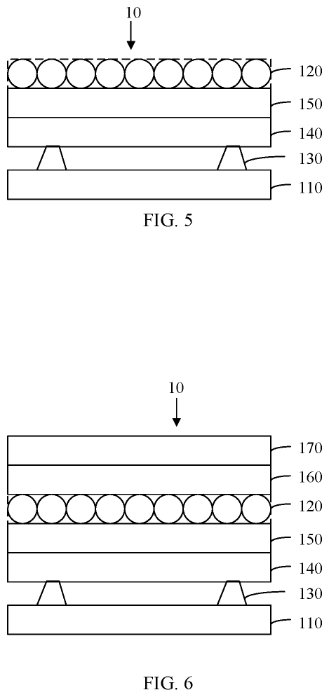

Based on any of the above embodiments, FIG. 5 is a schematic view of a backlight module according to a ninth embodiment of the present invention. Referring to FIG. 5, the backlight module 10 includes a light-emitting layer 110 and a brightness enhancing layer 120 disposed on the surface of the light-emitting layer 110, and the light-emitting layer 110 includes a plurality of Mini-LEDs emitting blue light. Also, between the light-emitting layer 110 and the brightness enhancing layer 120, the backlight module further comprises a support structure 130, a diffusion plate 140, and a quantum dot film 150.

The support structure 130 is disposed on the surface of the light-emitting layer 110. The diffusion plate 140 is disposed on the surface of the support structure 130 to make the blue light emitted by the light-emitting layer 110 more uniform. The quantum dot film 150 is disposed on the surface of the diffusion plate 140, and the blue light diffused by the diffusion plate 140 can uniformly excite the quantum dot film 150, so that the quantum dot film 150 emits green light and red light.

The brightness enhancing layer 120 is disposed on the surface of the quantum dot film 150.

In the backlight module 10 provided by the embodiment of the present invention, the brightness enhancement ratio of the brightness enhancing layer 120 is higher, so the amount of quantum dots in the quantum dot film 150 can be appropriately reduced, thereby saving the manufacturing cost of the backlight module 10.

Based on any of the above embodiments, FIG. 6 is a schematic view of a backlight module according to a tenth embodiment of the present invention. Referring to FIG. 6, the backlight module 10 further includes a diffusion sheet 160 and a dual brightness enhancement film 170. The diffusion sheet 160 is disposed on the surface of the brightness enhancing layer 120.

It should be noted that the brightness enhancing layer 120 can only enhance the light intensity of part of the light emitted by the light-emitting layer 110, so viewing angles of the red light and green light emitted by the quantum dot film 150 are lesser. At this time, the diffusion sheet 160 is disposed on the surface of the brightness enhancing layer 120 to increase the viewing angles of the red light and green light emitted by the quantum dot film 150.

The dual brightness enhancement film 170 is disposed on the surface of the diffusion sheet 160, and is used to convert unpolarized red light and unpolarized green light into polarized red light and polarized green light, thereby improving transmittance of the polarizer of the backlight module.

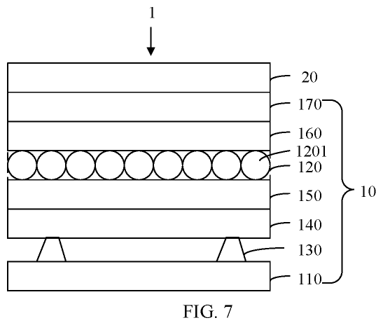

Based on any of the above embodiments, FIG. 7 is a schematic view of a display device according to an eleventh embodiment of the present invention. Referring to FIG. 7, the display device 1 in includes a display panel 20 and a backlight module 10. The backlight module 10 includes a light-emitting layer 110 and a brightness enhancing layer 120 disposed on the surface of the light-emitting layer 110.

The light-emitting layer 110 is a functional layer with a light-emitting function. For example, the light-emitting layer 110 may comprise a number of Mini-LEDs, a quantum dot (QD), light-emitting film, a dye light-emitting film, an organic light-emitting diode (OLED), or quantum dot light emitting diodes (QLED), which are not specifically limited in the embodiments of the present invention.

The brightness enhancing layer 120 is a functional layer with a brightness enhancement function. In the embodiment of the present invention, the brightness enhancing layer 120 includes a plurality of optical microcavities 1201. Among them, the optical microcavity 1201 is a shape-dependent optical resonant cavity, which mainly includes spherical, cylindrical, and annular shapes. The optical microcavity 1201 has a spherical shape as shown in FIG. 7.

As for each of the optical microcavities 1201, the light emitted from the light-emitting layer 110 into the optical microcavity 1201 is called incident light. Based on the resonance effect and antenna effect of the Whispering Gallery Mode (WGM) of the optical microcavity 1201, it can greatly increase the intensity of incident light at a specific wavelength and the light is emitted from the optical microcavity 1201 in a specific direction. For convenience of description, this part of the light is called resonant light.

As the intensity of the light is stronger, the brightness is greater, so the brightness of the resonant light is greatly improved compared to the incident light. The studies show that the brightness of the resonant light is increased by 2 to 3 orders of magnitude compared to the brightness of the incident light.

In the display device provided by the embodiment of the present invention, a brightness enhancing layer 120 is disposed on the surface of the light-emitting layer 110 in the backlight module 10. By designing the brightness enhancing layer 120 as an optical microcavity 1201, the intensity of part of the light emitted by the light-emitting layer 110 into the optical microcavity 1201 is greatly enhanced and emitted based on the resonance effect and antenna effect of the Whispering Gallery Mode (WGM) of the optical microcavity 1201, thereby greatly improving the brightness of the light-emitting layer 110. When the backlight module 10 is applied to the display device 1, the display brightness of the display device 1 can be greatly improved.

Based on any of the above embodiments, each of the optical microcavities 1201 is a solid cylindrical structure in second embodiment.

Based on any of the above embodiments, a refractive index of each of optical microcavities 1201 ranges from 1.8 to 2.5.

Specifically, in order to make the brightness of the resonant light emitted by the optical microcavity 1201 higher, the quality factor of the optical microcavity 1201 needs to be improved. The quality factor of the optical microcavity 1201 is related to its own refractive index and size, so the quality factor is improved based on the high refractive index. Therefore, in this embodiment, the refractive index of each optical microcavity 1201 is set to any value between 1.8 and 2.5.

Based on any of the above embodiments, transparent material of each of the optical microcavities 1201 includes any one or a combination of barium titanate (BaTiO₃), barium oxide (BaO), titanium dioxide (TiO₂), silicon dioxide, and lithium oxide (Li₂O) in fourth embodiment.

Specifically, the optical microcavity 1201 has a relatively high refractive index between 1.8 and 2.5, so a transparent material with a high refractive index is selected to manufacture the optical microcavity 1201. The material of optical microcavity 1201 in the embodiment of the present embodiment may be any one or a combination of BaTiO₃, BaO, TiO₂, SiO₂, and Li₂O. Of course, it may also be other transparent materials with high refractive index within 1.8-2.5, and is not specifically limited herein.

Based on any of the above embodiments, a diameter of each of the optical microcavities 1201 ranges from 20 to 200 μm in fifth embodiment.

Specifically, as the size of the optical microcavity 1201 is greater, the bending loss is lesser. Therefore, the quality factor is higher, the brightness of the resonant light emitted by the optical microcavity 1201 is higher. Accordingly, a diameter of the optical microcavity 1201 ranges from 20-200 μm. However, considering the complexity of the manufacturing process of the optical microcavity 1201 and other factors, the diameter of each optical microcavity 1201 preferably ranges from 40-60 μm in the embodiment of the present invention.

Based on any of the above embodiments, as shown in FIG. 2, the backlight module 10 includes a light-emitting layer 110 and a brightness enhancing layer 120 disposed on the surface of the light-emitting layer 110. The brightness enhancing layer 120 includes a plurality of optical microcavities 1201, which are uniformly arranged in a single-layered array.

Specifically, the brightness enhancing layer 120 includes twenty optical microcavities 1201. The twenty optical microcavities 1201 cover a large area of the surface of the brightness enhancing layer 120, and are uniformly arranged in a single-layered array of 4 columns×5 rows. The five optical microcavities 1201 in each column are spaced apart from each other, and four optical microcavities 1201 in each row are spaced apart from each other.

It should be noted that the arrangement of the optical microcavities 1201 on the surface of the light-emitting layer 110 is more uniform, the light emitted by the light-emitting layer 110 can be more uniformly improved in brightness. Referring to FIG. 2, the arrangement of the microcavities 1201 can make the light emitted by the light-emitting layer 110 more uniformly improved in brightness.

Based on any of the above embodiments, FIG. 3 is a top view of a backlight module according to seventh embodiment of the present invention. Referring to FIG. 3, the backlight module 10 includes a light-emitting layer 110 and a brightness enhancing layer 120 disposed on the surface of the light-emitting layer 110. The brightness enhancing layer 120 includes a plurality of optical microcavities 1201, which are uniformly arranged in a single-layered array, and each of the optical microcavities 1201 is tangent to at least two remaining optical microcavities 1201.

Specifically, the brightness enhancing layer 120 includes forty-two optical microcavities 1201. The forty-two optical microcavities 1201 cover a large area of the surface of the brightness enhancing layer 120, and are uniformly arranged in a single-layered array of 6 columns×7 rows. For each column, two adjacent optical microcavities 1201 are tangent to each other in the column of seven optical microcavities 1201. For each row, two adjacent optical microcavities 1201 are tangent to each other in the row of six optical microcavities 1201.

It should be noted that, the arrangement of the plurality of optical microcavities 1201 in the brightness enhancing layer 120 shown in FIG. 3 is more compact than that in FIG. 2, so the number of optical microcavities 1201 covering the surface of the light emitting-layer 110 is more. Compared with FIG. 2, the light emitted by the light-emitting layer 110 in FIG. 3 can be more uniformly brightened.

Based on any of the above embodiments, each of the optical microcavities 1201 is a solid cylindrical structure or a solid ring structure in eighth embodiment. FIG. 4 is a schematic view of an optical microcavity according to eighth embodiment of the present invention. The optical microcavity 1201 illustrated in part (a) of FIG. 4 is a solid cylindrical structure, and the optical microcavity 1201 illustrated in part (b) of FIG. 4 is a solid ring structure.

Based on any of the above embodiments, process of forming the brightness enhancing layer 120 on the surface of the light-emitting layer 110 is described as follows:

Step 1: providing a plurality of optical microcavities 1201, and the plurality of optical microcavities 1201 are sprayed onto the surface of the light-emitting layer 110, and the plurality of optical microcavities 1201 are attached to the surface of the light-emitting layer 110 by electrostatic force and Van der Waals force.

Step 2: An adhesive tape with low adhesion is pressed on the surface of the light-emitting layer 110. After a while, the adhesive tape is peeled off, so as to remove the optical microcavity 1201 that is not attached to the surface of the light-emitting layer 110.

Step 3: repeat Step 1 and Step 2 until the brightness enhancing layer 120 as shown in FIG. 2 or FIG. 3 is formed.

Based on any of the above embodiments, referring to FIG. 7, the backlight module 10 includes a light-emitting layer 110 and a brightness enhancing layer 120 disposed on the surface of the light-emitting layer 110, and the light-emitting layer 110 includes a plurality of Mini-LEDs emitting blue light. Also, between the light-emitting layer 110 and the brightness enhancing layer 120, the backlight module further comprises a support structure 130, a diffusion plate 140, and a quantum dot film 150.

The support structure 130 is disposed on the surface of the light-emitting layer 110. The diffusion plate 140 is disposed on the surface of the support structure 130 to make the blue light emitted by the light-emitting layer 110 more uniform. The quantum dot film 150 is disposed on the surface of the diffusion plate 140, and the blue light diffused by the diffusion plate 140 can uniformly excite the quantum dot film 150, so that the quantum dot film 150 emits green light and red light.

The brightness enhancing layer 120 is disposed on the surface of the quantum dot film 150.

In the display device 1 provided by the embodiment of the present invention, the brightness enhancement ratio of the brightness enhancing layer 120 in the backlight module 10 is higher, so the amount of quantum dots in the quantum dot film 150 can be appropriately reduced, thereby saving the manufacturing cost of the backlight module 10.

Based on any of the above embodiments, as shown in FIG. 7, the backlight module 10 further includes a diffusion sheet 160 and a dual brightness enhancement film 170. The diffusion sheet 160 is disposed on the surface of the brightness enhancing layer 120.

It should be noted that the brightness enhancing layer 120 can only enhance the light intensity of part of the light emitted by the light-emitting layer 110, so viewing angles of the red light and green light emitted by the quantum dot film 150 are lesser. At this time, the diffusion sheet 160 is disposed on the surface of the brightness enhancing layer 120 to increase the viewing angles of the red light and green light emitted by the quantum dot film 150.

The dual brightness enhancement film 170 is disposed on the surface of the diffusion sheet 160, and is used to convert unpolarized red light and unpolarized green light into polarized red light and polarized green light, thereby improving transmittance of the polarizer of the backlight module.

In the above embodiments, the description of each embodiment has its own emphasis. For a part that is not detailed in an embodiment, those of ordinary skill persons in the art can refer to the related descriptions of other embodiments.

It can be understood that, for those of ordinary skill persons in the art, equivalent replacements or changes can be made according to the technical solutions and inventive concepts of the present application, and all such changes or replacements should fall within the claimed scope of the present application.

What is claimed is:

1. A backlight module, comprising:
a light-emitting layer; and
a brightness enhancing layer disposed on a surface of the light-emitting layer, wherein the brightness enhancing layer comprises a plurality of optical microcavities, and each of the microcavities is configured to resonate a part of light emitted by and entering the light-emitting layer to obtain resonant light and emit the resonant light.

2. The backlight module according to claim 1, wherein each of the optical microcavities comprises a solid spherical structure.

3. The backlight module according to claim 2, wherein a refractive index of each of optical microcavities ranges from 1.8 to 2.5.

4. The backlight module according to claim 2, wherein material of each of the optical microcavities comprises any one or a combination of barium titanate, barium oxide, titanium dioxide, silicon dioxide, and lithium oxide.

5. The backlight module according to claim 2, wherein a diameter of each of the optical microcavities ranges from 20 to 200 μm.

6. The backlight module according to claim 2, wherein the plurality of the optical microcavities are uniformly arranged in a single-layered array.

7. The backlight module according to claim 6, wherein each of the optical microcavities is tangent to at least two remaining optical microcavities.

8. The backlight module according to claim 1, wherein each of the optical microcavities is a solid cylindrical structure or a solid ring structure.

9. The backlight module according to claim 1, wherein the light-emitting layer comprises a plurality of small light-emitting diodes emitting blue light, and between the light-emitting layer and the brightness enhancing layer, the backlight module further comprises:
a support structure disposed on the surface of the light-emitting layer;
a diffusion plate disposed on the surface of the support structure; and
a quantum dot film disposed on the surface of the diffusion plate;
wherein the brightness enhancing layer is disposed on a surface of the quantum dot film.

10. The backlight module according to claim 9, further comprising:
a diffusion sheet disposed on the surface of the brightness enhancing layer; and
a dual brightness enhancement film disposed on a surface of the diffusion sheet.

11. A display device, comprising:
a display panel; and
a backlight module;
wherein the backlight module comprises a light-emitting layer and a brightness enhancing layer, and the brightness enhancing layer is disposed on a surface of the light-emitting layer;
wherein the brightness enhancing layer comprises a plurality of optical microcavities, and each of the microcavities is configured to resonate a part of light emitted by and entering the light-emitting layer to obtain resonant light and emit the resonant light.

12. The display device according to claim 11, wherein each of the optical microcavities comprises a solid spherical structure.

13. The display device according to claim 12, wherein a refractive index of each of the optical microcavities ranges from 1.8 to 2.5.

14. The display device according to claim 12, wherein material of each of optical microcavities comprises any one or a combination of barium titanate, barium oxide, titanium dioxide, silicon dioxide, and lithium oxide.

15. The display device according to claim 12, wherein a diameter of each of the optical microcavities ranges from 20 to 200 μm.

16. The display device according to claim 12, wherein the plurality of the optical microcavities are uniformly arranged in a single-layered array.

17. The display device according to claim 16, wherein each of the optical microcavities is tangent to at least two remaining optical microcavities.

18. The display device according to claim 11, wherein each of the optical microcavities is a solid cylindrical structure or a solid ring structure.

19. The display device according to claim 11, wherein the light-emitting layer comprises a plurality of small light-emitting diodes emitting blue light, and between the light-emitting layer and the brightness enhancing layer, the backlight module further comprises:
a support structure disposed on the surface of the light-emitting layer;
a diffusion plate disposed on the surface of the support structure; and
a quantum dot film disposed on the surface of the diffusion plate;
wherein the brightness enhancing layer is disposed on a surface of the quantum dot film.

20. The display device according to claim 19, further comprising:
a diffusion sheet disposed on the surface of the brightness enhancing layer; and
a dual brightness enhancement film disposed on a surface of the diffusion sheet.
